(19) United States
(12) Patent Application Publication
(10) Pub. No.: US 2024/0361491 A1
(43) Pub. Date: Oct. 31, 2024

(54) INTEGRATED MONITORING SYSTEMS AND METHODS FOR MONITORING DEEP SUBSURFACE STORAGE OF A NATURAL GAS

(71) Applicant: Battelle Memorial Institute, Columbus, OH (US)

(72) Inventors: Richard PARKER, Houston, TX (US); Matthew D. McCHESNEY, Dallas, TX (US); Matthew WINDHOLTZ, Hilliard, OH (US); James E. RISSER, Lutherville Timonium, MD (US); Molly WILLIAMS, Louisville, KY (US)

(73) Assignee: BATTELLE MEMORIAL INSTITUTE, Columbus, OH (US)

(21) Appl. No.: 18/646,196

(22) Filed: Apr. 25, 2024

Related U.S. Application Data
(60) Provisional application No. 63/498,257, filed on Apr. 25, 2023.
(60) Provisional application No. 63/498,256, filed on Apr. 25, 2023.

(51) Int. Cl. G01V 11/00

(52) U.S. Cl. CPC G01V 11/002

(57) ABSTRACT

A system for integrated monitoring of a subsurface gas storage site including a power supply; the sensor platform including a plurality of sensors configured to collect monitoring data, where at least one sensor in the plurality of sensors includes a first sensor configured to collect first monitoring data on a first physical characteristic of the subsurface gas storage site; at least one sensor in the plurality of sensors includes a second sensor configured to collect second monitoring data on a second physical characteristic of the subsurface gas storage site; the first physical characteristic is a different physical characteristic than the second physical characteristic; and the sensor platform is configured to transmit the monitoring data to a processing computer; the processing computer configured to process the monitoring data, and transmit the monitoring data to a cloud computing platform; and the cloud computing platform.

### CROSS-REFERENCE TO RELATED PATENT APPLICATIONS

This application claims priority to U.S. Patent Appl. Ser. No. 63/498,257, filed Apr. 25, 2023, entitled “Integrated Monitoring Systems And Methods For Monitoring Deep Subsurface Storage Of Natural Gas,” which patent application is commonly owned by the owner of the present invention, and to U.S. Patent Appl. Ser. No. 63/498,256, filed Apr. 25, 2023, entitled “Integrated Monitoring Systems And Methods Relating Thereto,” which patent application is commonly owned by the owner of the present invention. These patent applications are incorporated herein in its entirety.

### TECHNICAL FIELD

The present disclosure relates to the field of carbon sequestration site monitoring. In particular, the present disclosure relates to an improved integrated monitoring system and methods for using such system to monitor subsurface migration of carbon dioxide (CO₂) injected into deep rock formations through continuous multi-physics data collection.

The present disclosure further relates to the field of subsurface storage monitoring. In particular, the present disclosure relates to an improved integrated monitoring system and methods for using such system to monitor subsurface storage of natural gases, such as hydrogen or methane gas, through continuous multi-physics data collection. The natural gases stored in the subsurface storage monitored by the improved integrated monitoring system and methods may be used for fuel purposes.

### STATEMENT OF FEDERALLY FUNDED RESEARCH

None.

### BACKGROUND

CO₂ is a naturally occurring chemical compound that is present in Earth's atmosphere as a gas. One significant source of atmospheric CO₂ is industrial plants, such as cement plants, refineries, steel mills, and coal-fired power plants. A variety of industrial power plant facilities combust various carbon-based fuels, such as fossil fuels and syngases, during their daily operations. Commonly employed fossil fuels include coal, petroleum coke, natural gas, oil, and biofuels. Fuels derived from oil shale, coal liquids, coal gasification, and biofuels may also be made via syngas.

The federal government, and in particular the Environmental Protection Agency, has repeatedly noted the importance of recognizing and mitigating the environmental effects of greenhouse gases such as CO₂. Due to production activities compiling since the industrial revolution, there has been concerning high concentrations of atmospheric CO₂. Additionally, anthropogenic CO₂ has been implicated in global warming and climate change, as well as increasing oceanic bicarbonate concentration.

The United States federal policies aimed at classifying and regulating CO₂ as an air pollutant fueled an urgency for effective long-term carbon capture and sequestration. Geologic carbon sequestration is the process of injecting CO₂ into deep subsurface rock formations for long-term storage. Such a process may be used for, but is not limited to, capturing carbon from an industrial source, energy related source, a highly pure stream, a complex flue stream, directly from air in the atmosphere, or combinations thereof. The process for carbon capture and sequestration begins with carbon capture through separating pure CO₂ from complex flue streams and compressing the purified CO₂, and subsequently follows with geologic carbon sequestration by injecting the purified CO₂ into an underground storage reservoirs.

CO₂ injection specifically for geologic carbon sequestration involves different technical issues and potentially much larger volumes of CO₂ than prior carbon injection practices related to oil and gas recovery.

Recognizing the heightened considerations associated with geologic carbon sequestration, the Environmental Protection Agency developed of a new class of wells, Class VI, under the authority of the Safe Drinking Water Act's Underground Injection Control program. These requirements, also known as the Class VI rule, are designed to protect underground sources of drinking water.

The Class VI rule builds on existing Underground Injection Control program requirements, with extensive tailored requirements that address CO₂ injection for long-term storage to ensure that wells used for geologic carbon sequestration are appropriately monitored. In particular, the criteria for Class VI wells includes comprehensive monitoring requirements that address all aspects of well integrity, CO₂ injection and storage, and ground water quality during the injection operation and the post-injection site care period.

Specifically, geologic carbon sequestration sites require monitoring of site conditions and underground CO₂ plumes throughout their life-cycles, which will extend for decades. The monitoring requirements include, but are not limited to, monitoring subsurface migration of injected CO₂; and direct and indirect measurements requirements during both the injection-monitoring period and post-injection-monitoring period to ensure the injected CO₂ remains within the project's allowable Area of Review. To receive a Class VI well permit from the Environmental Protection Agency's Underground Injection Control program requires that those managing the geologic carbon sequestration sites ensure that CO₂ does not move upward through the injection zone and confining zone into the underground sources of drinking water and that the location of the CO₂ is predicted by a subsurface model.

A failure to ensure that these requirements are met will result in a halt to the injection process. Further, if the CO₂ contained in the injection zone and confining zone migrates from the allowable zone for the CO₂ plume, then those managing the geologic carbon sequestration site could be subject to a pore space rights violation that leads to legal repercussions.

Current methods for following the monitoring requirements employ multiple individual sensor networks that mostly require manual operation accomplished through infrequent, costly site visits. Thus, the determination of a pore space rights violation may take five years of monitoring under current practices to identify. By such time, those managing the geologic carbon sequestration site cannot correct the harm caused by the pore space rights violation. Further, it may take five years for those managing the geologic carbon sequestration site to determine whether the pore space utilization of the CO₂ plume is efficient. Due to the current methods for following the monitoring requirements, which may take five years of regulatory monitoring to determine utilization, there are heightened risks of reduced injection volume in the injection zone.

Accordingly, effective site integrity monitoring was by far the highest-ranking critical need for the geologic carbon sequestration market as identified at the Society of Exploration Geophysicist (SEG)'s Summer Research Workshop, “Toward Gigatonnes CO₂ Storage—Grand Geophysical Challenge”, Stanford, CA, 26-30 Jun. 2022.

Thus, there is a need for a cost-effective and high-fidelity monitoring system that is designed for long-term CO₂ sequestration monitoring.

Further, in respect to gases beyond CO₂, subsurface storage may require a cost-effective and high-fidelity monitoring system that is designed for long-term use.

For example, hydrogen has a wide variety of uses in industrial and commercial operation, including in oil and gas production and refining. Hydrogen can be used in such operations as a propellant, a carrier gas, a diluent gas, a reducing agent or a fuel component. As another example, methane has a wide variety of uses as a fuel source, such as the use of methane as fuel in gas turbines and steam generators.

In fact, gases such as hydrogen or methane may be utilized as an alternative fuel for centralized and distributed power generation as well as transportation vehicles. Hydrogen in particular has been focused on as a fuel source because of the clean, abundant, and emission-free capabilities of such a fuel.

These gaseous fuel sources often need a location for storage between collection and distribution. After gas is compressed and stored in preparation for fuel purposes, the gas must then be stored in an area that can provide sufficient storage capacity for the gaseous fuel without incurring significant costs. Current programs are employed in areas including the Netherlands, Austria, and Argentina to demonstrate the technical, economic, and social viability of subsurface gaseous hydrogen fuel storage. The programs are storing gas through a process similar to that of carbon capture and sequestration. Specifically, the process begins with gaseous fuel capture through separating H₂ and compressing the purified H₂, and subsequently follows with geologic sequestration by injecting the combined H₂ and CO₂ into a subsurface storage reservoirs.

Thus, subsurface gaseous fuel storage sites require monitoring of site conditions and subsurface gas containing vessels for significant periods of time. Current methods of monitoring employ multiple individual sensor networks that mostly require manual operation accomplished through infrequent, costly site visits. Thus, the process for monitoring such sites can be costly and inefficient. Due to these inefficiencies, there are heightened risks of reduced utilization of a gaseous fuel storage zone and reduced awareness of gaseous fuel to migration outside of an allowable gaseous fuel storage zone.

Accordingly, similar to the monitoring needed for CO₂ sequestration sites, gaseous fuel storage sites have a critical need for effective site integrity monitoring.

### SUMMARY OF THE DISCLOSURE

The present disclosure is directed to systems and a method for integrated monitoring of carbon sequestration sites or subsurface gaseous fuel storage sites. The integrated monitoring system includes multiple integrated monitored stations that each continuously operate and report a multitude of sensor readings regarding the carbon sequestration site or subsurface gaseous fuel storage site to a service platform.

To address the need disclosed above, the integrated monitoring system utilizes a service platform that communicatively couples the integrated monitoring stations using edge computing to allow for optimal data storage and transmission. Accordingly, in certain embodiments, the integrated monitoring system is capable of reducing design time for a carbon sequestration site, facilitating the process for obtaining a Class VI well permit, lowering the operating cost of a CO₂ sequestration monitoring system, enabling a common monitoring network across a geologic carbon sequestration site, providing an advanced and prompt warning of containment issues within the CO₂ injection zone, and thereby lowering the risks involved with CO₂ sequestration. Furthermore, the integrated monitoring system is capable of collecting data more frequently than required by Class VI regulations thus facilitating advanced indication of CO₂ plume movement allowing the site operator to pro-actively adjust the CO₂ injection to optimize the use of available pore space.

Moreover, in other embodiments, the integrated monitoring system is capable of reducing design time for a subsurface gaseous fuel storage site, lowering the operating cost of a gas storage monitoring system, enabling a common monitoring network across a subsurface gaseous fuel storage site, providing an advanced and prompt warning of containment issues within the gas storage zone, and thereby lowering the risks involved with subsurface gaseous fuel storage.

Further, the integrated monitoring system can enable underground plume visualization and optimization of site usage. In addition, in certain embodiments, the integrated monitoring system can allow for monitoring of the quality of the underground fuel or subsurface conditions that might degrade the stored natural gas that is intended to be used as fuel when later retrieved from the deep subsurface storage site.

In general, in one embodiment, the disclosure features a system for integrated monitoring of subsurface migration of CO₂ injected into deep rock formations. The system can include a power supply configured to supply power to a sensor platform. The sensor platform can include a plurality of sensors configured to collect monitoring data. At least one sensor in the plurality of sensors can include a first sensor configured to collect first monitoring data on a first physical characteristic of a carbon sequestration site. The first physical characteristic can be selected from the group consisting of seismicity, near surface deformation, surface deformation, groundwater chemistry, gravity, atmospheric CO₂, soil CO₂, and CO₂ plume location. At least one sensor in the plurality of sensors can include a second sensor configured to collect second monitoring data on a second physical characteristic of the carbon sequestration site. The second physical characteristic can be selected from the group consisting of seismicity, near surface deformation, surface deformation, groundwater chemistry, gravity, atmospheric CO₂, soil CO₂, and CO₂ plume location. The first physical characteristic can be a different physical characteristic than the second physical characteristic. The monitoring data can include the first monitoring data on the first physical characteristic and the second monitoring data on the second physical characteristic. The sensor platform can be configured to transmit the monitoring data to a processing computer. The system can further include the processing computer configured to process the monitoring data and transmit the monitoring data to a cloud computing platform. The system can further include the cloud computing platform communicatively coupled to the processing computer of the sensor platform.

In general, in another embodiment, the disclosure features an integrated monitoring station system. The integrated monitoring station system can include a plurality of sensors configured to collect monitoring data. At least one sensor in the plurality of sensors can include a first sensor configured to monitor a first physical characteristic of a carbon sequestration site. The first physical characteristic can be selected from the group consisting of seismicity, near surface deformation, surface deformation, groundwater chemistry, gravity, atmospheric CO₂, soil CO₂, and CO₂ plume location. At least one sensor in the plurality of sensors can include a second sensor configured to monitor a second physical characteristic of the carbon sequestration site. The second physical characteristic can be selected from the group consisting of seismicity, near surface deformation, surface deformation, groundwater chemistry, gravity, atmospheric CO₂, soil CO₂, and CO₂ plume location. The first physical characteristic can be a different physical characteristic than the second physical characteristic. The system can further include an edge computing network communicatively coupled to the plurality of sensors. The edge computing network can be configured to store the monitoring data, process the monitoring data, and transmit the monitoring data to a cloud computing platform.

In general, in another embodiment, the disclosure features a system for integrated monitoring of a subsurface gas storage site. The system can include a power supply configured to supply power to a sensor platform. The sensor platform can include a plurality of sensors configured to collect monitoring data. At least one sensor in the plurality of sensors can include a first sensor configured to collect first monitoring data on a first physical characteristic of the subsurface gas storage site. The first physical characteristic can be selected from the group consisting of seismicity, near surface deformation, surface deformation, groundwater chemistry, gravity, atmospheric condition, soil condition, and subsurface storage location. At least one sensor in the plurality of sensors can include a second sensor configured to collect second monitoring data on a second physical characteristic of the subsurface gas storage site. The second physical characteristic can be selected from the group consisting of seismicity, near surface deformation, surface deformation, groundwater chemistry, gravity, atmospheric condition, soil condition, and subsurface storage location. The first physical characteristic can be a different physical characteristic than the second physical characteristic. The monitoring data can include the first monitoring data on the first physical characteristic and the second monitoring data on the second physical characteristic. The sensor platform can be configured to transmit the monitoring data to a processing computer. The system can further include the processing computer configured to process the monitoring data and transmit the monitoring data to a cloud computing platform. The system can further include the cloud computing platform communicatively coupled to the processing computer of the sensor platform.

In general, in another embodiment, the disclosure features an integrated monitoring station system. The integrated monitoring station system can include a plurality of sensors configured to collect monitoring data. At least one sensor in the plurality of sensors can include a first sensor configured to monitor a first physical characteristic of a subsurface gas storage site. The first physical characteristic can be selected from the group consisting of seismicity, near surface deformation, surface deformation, groundwater chemistry, gravity, atmospheric condition, soil condition, and subsurface storage location. At least one sensor in the plurality of sensors can include a second sensor configured to monitor a second physical characteristic of the subsurface gas storage site. The second physical characteristic can be selected from the group consisting of seismicity, near surface deformation, groundwater chemistry, gravity, atmospheric condition, soil condition, and subsurface storage location. The first physical characteristic can be a different physical characteristic than the second physical characteristic. The system can further include an edge computing network communicatively coupled to the plurality of sensors. The edge computing network can be configured to store the monitoring data, process the monitoring data, and transmit the monitoring data to a cloud computing platform.

### BRIEF DESCRIPTION OF THE DRAWINGS

Other advantages of the present disclosure will be apparent from the following detailed description of the disclosure in conjunction with embodiments as illustrated in the accompanying drawings, in which:

FIG. 1 depicts a front view of an integrated monitoring station that utilizes multiple sensor types, edge computing, and data storage and transmission to monitor gas stored in a subsurface reservoir, in accordance with certain embodiments of the present disclosure.

FIG. 2A depicts a schematic view of the sensing capabilities of a standalone integrated monitoring station, in accordance with certain embodiments of the present disclosure.

FIG. 2B depicts a schematic view of the sensing capabilities of a water well integrated monitoring station, in accordance with certain embodiments of the present disclosure.

FIG. 2C depicts a schematic view of the sensing capabilities of an above-confining zone (ACZ) integrated monitoring station, in accordance with certain embodiments of the present disclosure.

FIG. 2D depicts a schematic view of the sensing capabilities of a deep monitor well integrated monitoring station, in accordance with certain embodiments of the present disclosure.

FIG. 2E depicts a schematic view of the sensing capabilities of a CO₂ emission monitoring system integrated monitoring station, in accordance with certain embodiments of the present disclosure.

FIG. 3 depicts a cross sectional view of an integrated monitoring system that includes multiple integrated monitoring stations, in accordance with certain embodiments of the present disclosure.

FIG. 4 depicts a block diagram of a platform design for an integrated monitoring system, in accordance with certain embodiments of the present disclosure.

FIG. 5 depicts a block diagram of software architecture for an integrated monitoring system that includes multiple integrated monitoring stations, in accordance with certain embodiments of the present disclosure.

### NOTATION AND NOMENCLATURE

Various terms are used to refer to particular system components. Different companies may refer to a component by different names—this document does not intend to distinguish between components that differ in name but not function. In the following discussion and in the claims, the terms “including” and “comprising” are used in an open-ended fashion, and thus should be interpreted to mean “including, but not limited to. . . . ” Also, the term “couple” or “couples” is intended to mean either an indirect or a direct connection. Thus, if a first device couples to a second device, that connection may be through a direct connection or through an indirect connection via other devices and connections.

The terminology used herein is for the purpose of describing particular example embodiments only, and is not intended to be limiting. Following long-standing patent law convention, the terms “a” and “an” mean “one or more” when used in this application, including the claims.

As used herein, the singular forms “a,” “an,” and “the” may be intended to include the plural forms as well, unless the context clearly indicates otherwise. The method steps, processes, and operations described herein are not to be construed as necessarily requiring their performance in the particular order discussed or illustrated, unless specifically identified as an order of performance. It is also to be understood that additional or alternative steps may be employed.

The terms first, second, third, etc. may be used herein to describe various elements, components, regions, layers and/or sections; however, these elements, components, regions, layers and/or sections should not be limited by these terms. These terms may be only used to distinguish one element, component, region, layer, or section from another region, layer, or section. Terms such as “first,” “second,” and other numerical terms, when used herein, do not imply a sequence or order unless clearly indicated by the context. Thus, a first element, component, region, layer, or section discussed below could be termed a second element, component, region, layer, or section without departing from the teachings of the example embodiments. The phrase “at least one of,” when used with a list of items, means that different combinations of one or more of the listed items may be used, and only one item in the list may be needed. As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D. Accordingly, as an example, “at least one of: A, B, and C” includes any of the following combinations: A, B, C, A and B, A and C, B and C, and A and B and C. In another example, the phrase “one or more” when used with a list of items means there may be one item or any suitable number of items exceeding one.

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of the device in use, or operation, in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

Unless otherwise indicated, all numbers expressing quantities of ingredients, reaction conditions, and so forth used in the specification are to be understood as being modified in all instances by the term “about.” Accordingly, unless indicated to the contrary, the numerical parameters set forth in this specification are approximations that can vary depending upon the desired properties sought to be obtained by the presently disclosed subject matter.

### DETAILED DESCRIPTION OF THE DISCLOSURE

The present disclosure provides systems and methods for providing cost-effective CO₂ assurance, verification monitoring for carbon sequestration, and verification monitoring for subsurface gaseous fuel storage sites. In particular, the present disclosure provides an integrated monitoring system based on a system-of-systems approach that integrates multiple integrated monitoring stations into a site-wide network that is monitored and controlled through a service platform.

In some embodiments, the integrated monitoring system provides a multi-physics platform to streamline the field deployment, data collection, and maintenance of geologic carbon sequestration monitoring networks. Through the use of such an integrated monitoring system, the required monitoring of a geographic carbon sequestration site can be continuously performed by an integrated network, reducing the overall cost and increasing the consistency of the carbon monitoring.

The integrated monitoring system, in some embodiments, provides a continuous remote monitoring of required parameters. For example, in certain embodiments, the integrated monitoring system may monitor the seismic activity, presence of CO₂ in water aquifers, or combinations thereof based on the data collection using multiple sensors in integrated monitoring stations. For example, in other embodiments of the present disclosure, the integrated monitoring system may monitor the seismic activity, chemical contents in water aquifers, or combinations thereof based on the data collection using multiples sensors in integrated monitoring stations located in areas with subsurface gaseous fuel storage. Because of the continuous remote monitoring, the integrated monitoring system can reduce field man hours, which will lead to overall reduced cost, reduced safety risk, reduced environmental impact for the geologic carbon sequestration site using the integrated monitoring system.

In some embodiments, the continuous data collection allows for on-demand retrieval of the collected data. The prompt and continuous collection of data, in such an embodiments, may allow for earlier detection of issues at the geologic carbon sequestration site and may enable optimized risk management. Moreover, in embodiments utilizing the on-demand data collection with a model of the geologic carbon sequestration site, the integrated monitoring system enables early demonstration of plume stability and accuracy of modeling predictions, which may shorten the duration of the post injection monitoring phase.

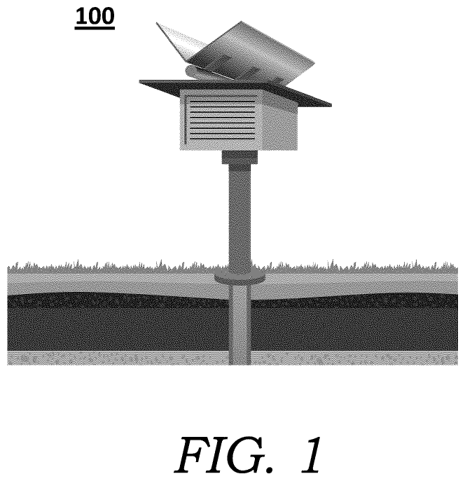

FIG. 1 depicts a front view of an integrated monitoring station that utilizes multiple sensor types, edge computing, and data storage and transmission to monitor gas stored in a subsurface reservoir, in accordance with certain embodiments of the present disclosure. In certain embodiments, the integrated monitoring system may be used to monitor geologic carbon sequestration. In other embodiments, the integrated monitoring system may be used to monitor gaseous fuels sequestered in subsurface storage sites.

Further, in embodiments where the stored gaseous fuel is periodically retrieved for use from the subsurface gaseous fuel storage site, the integrated monitoring system may be used to continuously monitor conditions at the subsurface gaseous fuel storage site.

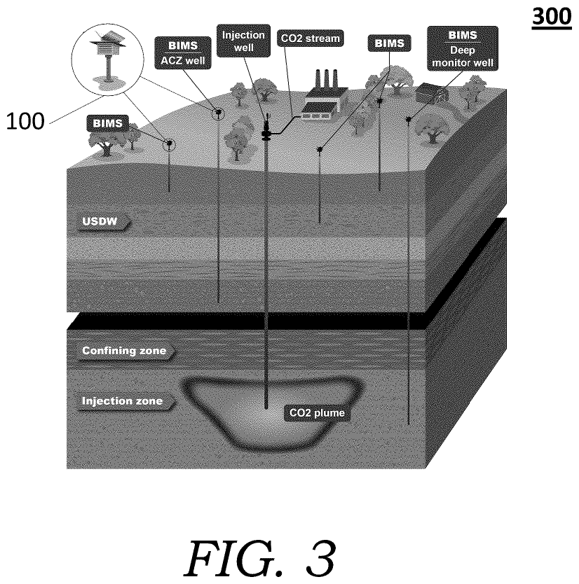

The integrated monitoring station 100 is a multi-physics product that integrates multiple sensor types into a single monitoring station. In some embodiments, the integration of multi-physics sensors that possess long-term stability may provide the data collected from the sensor to a unified database. As discussed in more detail in respect to FIG. 3 below, in certain embodiments, when the data in the unified database is coupled with advanced data analytics, the integrated monitoring system provides continual monitoring of carbon sequestration sites and early warning of issues that must be addressed to maintain a geologic carbon sequestration site in accordance with Environmental Protection Agency's regulations regarding Class VI wells. In some embodiments, the integrated monitoring system provides continual monitoring of a subsurface gaseous fuel storage site and may issue an early warning if the data collected by the sensors indicates that the present characteristics differ from those expected for subsurface storage site.

The integrated monitoring station 100 utilizes a plurality of sensors. In some embodiments, the integrated monitoring station 100 includes sensors that may measure seismic activity, surface deflection, water chemistry, micro-gravity, electro-magnetic forces, and combinations thereof.

In some embodiments, an integrated monitoring station 100 may include five sensors, where each of the five sensors measures a different characteristic related to the monitoring requirements of the geologic carbon sequestration site. Other embodiments may include five sensors, where each of the fives sensors measures a different characteristic related to the monitoring of a deep subsurface storage site. In some embodiments, the integrated monitoring station 100 includes a subset of the types of sensors present throughout the integrated monitoring system.

For example, the integrated monitoring station 100 may include an induced seismicity sensor. In such an embodiment, the induced seismicity sensor can record data associated with the seismic activity caused by the industrial process interaction that occurs from the geologic carbon sequestration or containment of a gaseous fuel in a subsurface storage site. In particular embodiments, the seismic sensors may be fiberoptic-based sensors that are configured to provide information on the movement of the injectant into the monitored site over time.

As another example, the integrated monitoring station 100 may include a corner reflector. In such an embodiment, the corner reflector can facilitate recording data associated with the movement of the surface of the site from the original position prior to injecting the CO₂ and perform comparative measurements to show the changes in deflection long-term. Further, in some embodiments, the corner reflector can facilitate recording data associated with the movement of the surface of the site from the original position prior to the subsurface storage of a gaseous fuel and perform comparative measurements to show the changes in deflection long-term. In some embodiments, the integrated monitoring station 100 may include a tilt-meter.

As another example, the integrated monitoring station 100 may include a water chemistry sensor. In such an embodiment, the water chemistry sensor can record data associated with the amount of dissolved CO₂ present in ground water located above or near to the injection zone where the CO₂ is contained in the deep rock formation. In other embodiments, the water chemistry sensor can record data on the chemical components present within the ground water located above or near a storage zone where gaseous fuel is contained subsurface.

As another example, the integrated monitoring station 100 may include a micro-gravity sensor. In such an embodiment, the micro-gravity sensor can measure changes in gravitational force due to the subsurface injection of CO₂. In another embodiment, the micro-gravity sensor can measure changes in gravitational force due to the subsurface injection of the gaseous fuel.

As another example, the integrated monitoring station 100 may include an active seismic sensor. In such an embodiment, the active seismic sensor can record data associated with the displacement, velocity, or acceleration of the ground movement in the geologic carbon sequestration site or subsurface gaseous fuel storage site.

In some embodiments, the integrated monitoring station 100 may include a seismic source that generates controlled seismic energy near the location of the geologic carbon sequestration site. In other embodiments, the integrated monitoring station 100 may include a seismic source that generates controlled seismic energy near the location of the subsurface gaseous fuel storage site. In such an embodiment, the software system of an integrated monitoring system may remotely trigger the seismic source in the integrated monitoring station 100. In certain embodiments, the seismic source may be triggered to generate controlled seismic energy based on a pre-set schedule. In other embodiments, the seismic source may be triggered to generate controlled seismic energy based on a remote instruction to the integrated monitoring system.

As another example, the integrated monitoring station 100 may include an electro-magnetic sensor. In such an embodiment, the electro-magnetic sensor can record data associated with the changes in the electrical resistivity at the geologic carbon sequestration site or the subsurface gaseous fuel storage site and use such data to determine resistivity.

As another example, the integrated monitoring station 100 may include a CO₂ emission monitoring system. In such an embodiment, the CO₂ emission monitoring system can record data based on continuous, real-time measurements of changes in near surface atmospheric changes in CO₂ concentrations.

As another example, the integrated monitoring station 100 may include an emission monitoring system for a targeted natural gas. In such an embodiment, the emission monitoring system can record data based on continuous, real-time measurements of changes in near surface atmospheric changes in concentrations of natural gases, such as for example methane.

As another example, the integrated monitoring station 100 may include a muon detection sensor. In such an embodiment, the muon detection sensor may perform a subsurface imaging technique that is highly sensitive to density contrasts. From this, in such an embodiment, the muon detection sensor may be used to create tomographic images based on the collected data and an earth model.

As another example, the integrated monitoring station 100 may include an in-situ XRF detection sensor. In such an embodiment, the in-situ XRF detection sensor can record data associated with the elemental composition of materials located in the ground between the injection zone and the surface of the geologic carbon sequestration site. In some embodiments, the in-situ XRF detection sensor can record data associated with the elemental composition of materials located in the ground between the storage zone and the ground-level surface subsurface gaseous fuel storage site.

As another example, the integrated monitoring station 100 may include a sensor for detecting the migration of targeted natural gases. In such an embodiment, the detection sensor may collect readings to determine whether a natural gas contained in the deep subsurface storage site has migrated beyond the intended storage zone. From this, in such an embodiment, the detection sensor may be used to identify and alert those monitoring the site to the migration of one or more natural gases, such as for example hydrogen gas or methane gas.

As another example, in embodiments where the natural gas present in the deep subsurface storage is later retrieved from the storage for use, the integrated monitoring station 100 may include sensors to identify subsurface microbes that could degrade the stored fuel, sensors to evaluate the quality or purity of the fuel during removal, monitoring of underground plume migration into areas from which the gas is unrecoverable, and combinations thereof.

The sensors in the integrated monitoring station 100 can be used to collect monitoring data on one or more physical characteristics of a subsurface sequestration site. In some embodiments, the sensors in the integrated monitoring station 100 can collect monitoring data on characteristics using a sensor to sense and take readings directed to a particular characteristic. As one example, in certain embodiments, the integrated monitoring station 100 can include a micro-gravity sensor that measures changes in gravitational force and collects such measurements. In such an embodiment, the directly collected data would provide monitoring information on the physical characteristic of gravity. In some embodiments, the sensors in the integrated monitoring station 100 can collect monitoring data on characteristics using one or more sensors that sense and take readings that then allow for a determination of the physical characteristic. For example, the integrated monitoring station 100 can include a muon detection sensor to sense subsurface density contrasts. In such an embodiment, the collected data would allow for the creation of tomographic images. Accordingly, in certain embodiments, the collected data would provide monitoring information on the physical characteristic of CO₂ plume location. In certain other embodiments, the collected data would provide monitoring information on the physical characteristic of subsurface gaseous fuel storage location.

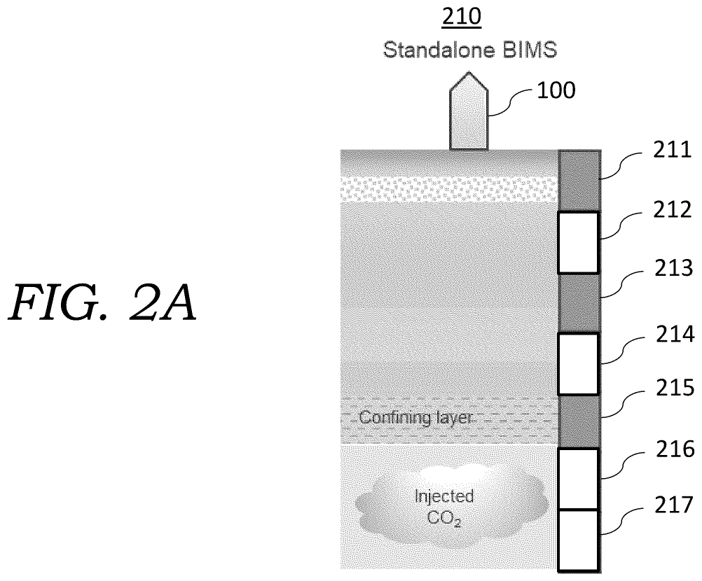

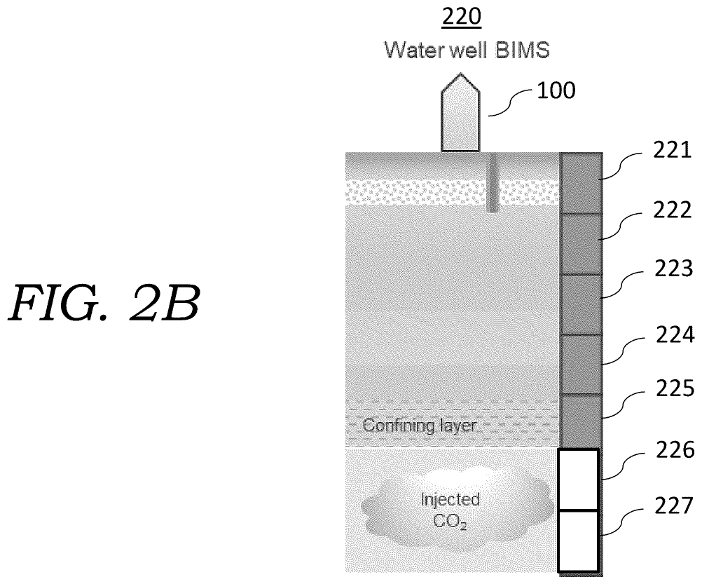

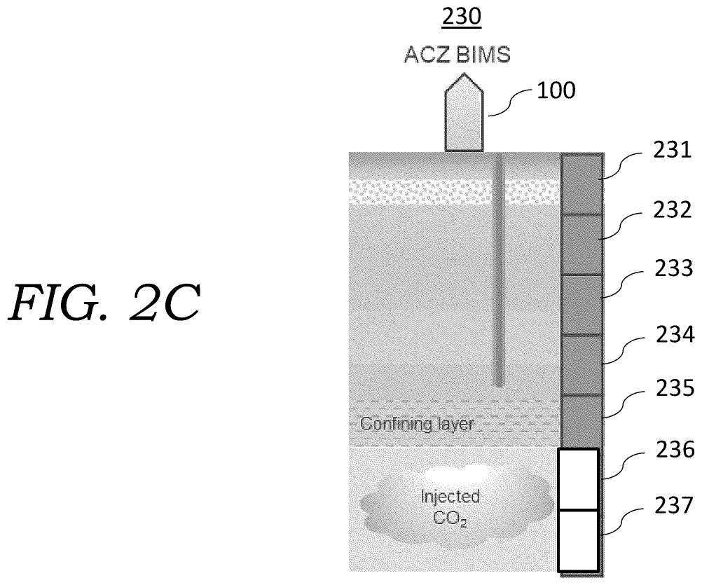

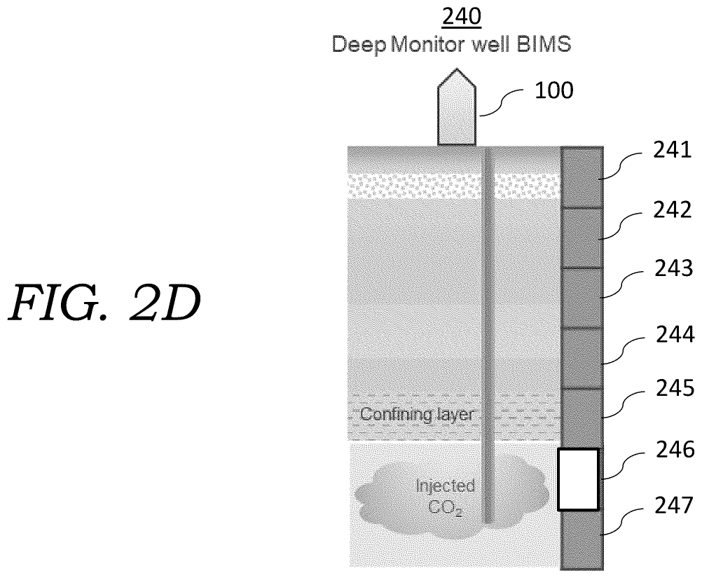

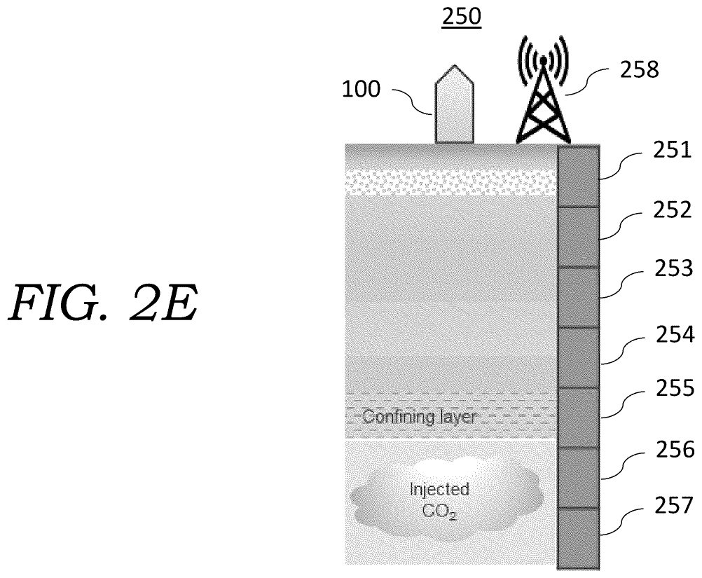

For FIGS. 2A-2E, the sensing capabilities of a variety of integrated monitoring stations are provided. Specifically, as shown in FIGS. 2A-2E, a filled in block depicts that the particular type of integrated monitoring station is suitable for measuring a characteristic that is to be monitored for geologic carbon sequestration projects and a required to be monitored for a Class VI permit. Such monitoring types may also show suitability for monitoring of a subsurface fuel storage site. Accordingly, based on the landscape and conditions of a particular geologic gas sequestration project, multiple of the integrated monitoring stations as shown through FIGS. 2A-2E may be placed in an integrated monitoring system to optimize the collection of data for monitoring subsurface migration of injected CO₂ or other storage gases.

The capability of measuring seismicity is provided in 211, 221, 231, 241, and 251 for FIGS. 2A-2E, respectively. The capability of measuring near surface deformation is provided in 212, 222, 232, 242, and 252 for FIGS. 2A-2E, respectively. The capability of measuring surface deformation is provided in 213, 223, 233, 243, and 253 for FIGS. 2A-2E, respectively. The capability of measuring groundwater chemistry is provided in 214, 224, 234, 244, and 254 for FIGS. 2A-2E, respectively. The capability of measuring gravity is provided in 215, 225, 235, 245, and 255 for FIGS. 2A-2E, respectively. The capability of measuring atmospheric CO₂ is provided in 216, 226, 236, 246, and 256 for FIGS. 2A-2E, respectively. The capability of mapping the soil CO₂ is provided in 217, 227, 237, 247, and 257 for FIGS. 2A-2E, respectively. The capability of mapping the CO₂ plume is provided in 217, 227, 237, 247, and 257 for FIGS. 2A-2E, respectively.

FIG. 2A depicts a schematic view of the sensing capabilities of a standalone integrated monitoring station 210, in accordance with certain embodiments of the present disclosure. The standalone integrated monitoring station 210 is capable of measuring seismicity 211, surface deformation 213, and gravity 215.

FIG. 2B depicts a schematic view of the sensing capabilities of a water well integrated monitoring station 220, in accordance with certain embodiments of the present disclosure. The water well integrated monitoring station 220 is capable of measuring seismicity 221, near surface deformation 222, surface deformation 223, groundwater chemistry 224, and gravity 215.

FIG. 2C depicts a schematic view of the sensing capabilities of an ACZ integrated monitoring station 230, in accordance with certain embodiments of the present disclosure. The ACZ integrated monitoring station 230 is capable of measuring seismicity 231, near surface deformation 232, surface deformation 233, groundwater chemistry 234, and gravity 235.

FIG. 2D depicts a schematic view of the sensing capabilities of a deep monitor well integrated monitoring station 240, in accordance with certain embodiments of the present disclosure. The deep monitor well integrated monitoring station 240 is capable of measuring seismicity 241, near surface deformation 242, surface deformation 243, groundwater chemistry 244, and gravity 245. In addition to these monitoring capabilities, the deep monitor well integrated monitoring station 240 is configured to providing a mapping of the CO₂ located in the deep rock formation 247.

FIG. 2E depicts a schematic view of the sensing capabilities of an Surface/Near-Surface Monitoring (SNSM) integrated monitoring station 250, in accordance with certain embodiments of the present disclosure. The SNSM integrated monitoring station 250 is capable of measuring seismicity 251, near surface deformation 252, surface deformation 253, groundwater chemistry 254, gravity 255, and atmospheric CO₂ 256. In addition to these monitoring capabilities, the deep monitor well integrated monitoring station 240 is configured to providing a mapping of the CO₂ located in the deep rock formation 247.

FIG. 3 depicts a cross sectional view of an integrated monitoring system 300 that includes multiple integrated monitoring stations 100, in accordance with certain embodiments of the present disclosure. As noted above in respect to FIGS. 2A-2E, based on the landscape and conditions of a particular geologic carbon sequestration project, multiple of the integrated monitoring stations as shown through FIGS. 2A-2E may be placed in an integrated monitoring system to optimize the collection of data for monitoring subsurface migration of injected CO₂.

In embodiments such as Class VI wells or other carbon sequestration sites, a CO₂ stream is removed from a housing and injected into an injection zone for long-term storage. The housing where the CO₂ is removed from can be, in some embodiments, a coal-fired power plant or manufacturing facility with CO₂ product resultant from the operations. In some embodiments, after the CO₂ is captured or produced, the CO₂ can be compressed and transported to a different site where it is injected underground. In such an embodiment, the housing may be the container where the CO₂ has been temporarily compressed and held in for transportation.

The process for reducing emissions of CO₂ into the atmosphere involves flowing the CO₂ stream into an injection well, as shown in FIG. 3. The CO₂ is then injected into an injection zone. As depicted by the cross-sectional view of FIG. 3, the injection zone is located in a deep rock formation below a confining zone. The injection of CO₂ creates a plume, which is then held within the injection zone.

The deep rock formations that serve as injection zones are located below underground source of drinking water. In order to protect underground sources of drinking water, the Environmental Protection Agency has created requirements for maintaining a Class VI well that include comprehensive monitoring requirements that address all aspects of well integrity, CO₂ injection and storage, and ground water quality during the injection operation and the post-injection site care period.

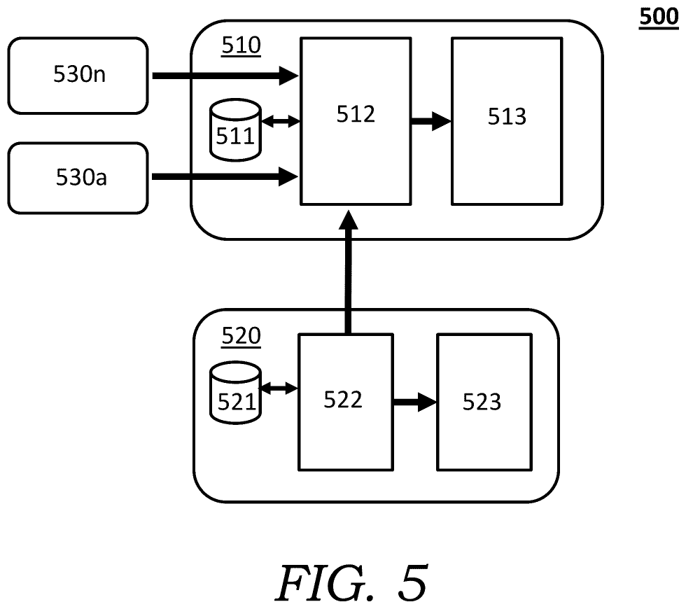

FIG. 3 depicts multiple integrated monitoring stations 100 deployed in a site-wide network to form the integrated monitoring system 300. The integrated monitoring system 300 depicted in FIG. 3 can be monitored and controlled through a service platform, as discussed in detail below in reference to FIG. 5.

The integrated monitoring system 300 provides multiple continuous sensors in integrated monitoring stations 100, which are placed around the carbon sequestration site. The integrated monitoring stations, in some embodiments, transmit the collected data and the control information from the local storage to an integrated monitoring hub using an on-board messaging platform. In some embodiments, the transmission of information between components in the integrated monitoring system is wireless.

In some embodiments, the integrated monitoring hub then transmits the collected data and the control information from the local storage to a cloud-based edge computer network using an on-board messaging platform.

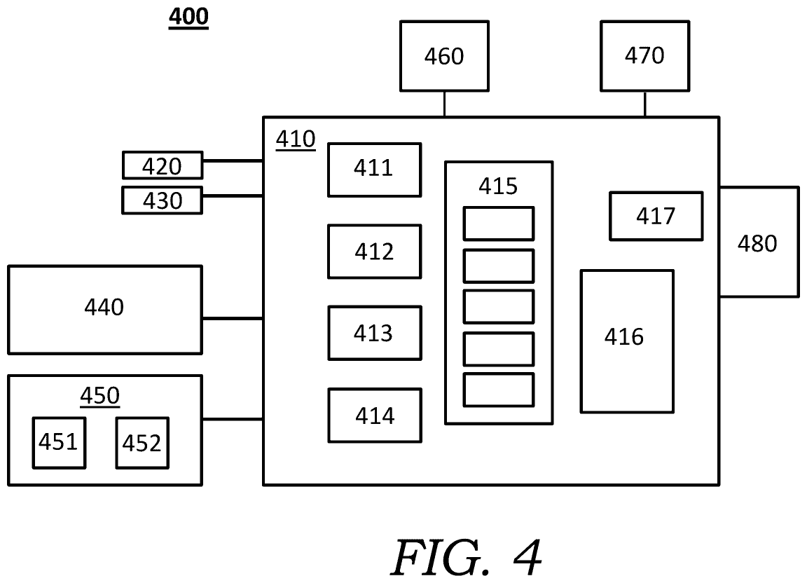

The cloud computing platform of the system platform, which is discussed in detail in relation to FIG. 4 below, may include a cloud database. In some embodiments, the data stored in the cloud database may be analyzed and used to create a visual representation of the effects of geologic carbon sequestration at the site based on the data.

In some embodiments, the cloud computing platform performs automated health monitoring of the multiple continuous sensors based on the received collected data. In such an embodiment, the cloud computing platform compares the collected data to the requirements for geologic carbon sequestration sites. For example, the requirements may be based on the requirements for maintaining a Class VI well provided by the Environmental Protection Agency. If the collected data does not conform to the requirements for geologic carbon sequestration sites, then the cloud computing platform may classify the data as below a threshold health value.

Additionally, in some embodiments, the cloud computing platform performs automated health monitoring of the integrated monitoring system based on the received collected data. In such an embodiment, the cloud computing platform analyzes the collected data to confirm the functionality of the components in the integrated monitoring system. If the collected data indicates a problem with the functionality of one or more components in the integrated monitoring system, then the cloud computing platform may classify the data as below a threshold health value.

In some embodiments, the information on the cloud computing platform of the system platform is accessible on a user interface. Further, in some embodiments, the cloud computing platform includes a notification engine that may notify the Environmental Protection Agency, States Agencies, a group of operational engineers, or a combination thereof when there is an issue with the geologic carbon sequestration site, such as when the automated health monitoring indicates that one or more of the multiple continuous sensors or the integrated monitoring system is below the threshold health value.

In some embodiments, the integrated monitoring system may further use a static earth model and a dynamic reservoir model of the geologic carbon sequestration site in conjunction with physics-based simulations of the geologic carbon sequestration site, a layout of the geologic carbon sequestration site, such as the depiction shown in FIG. 3 may be determined.

The physics-based simulation may provide a model for expected wavefield based on seismic activity sensing, a flow and deformation model based on surface deflection sensing, a resistivity based on electro-magnetic sensing, and a gravity model based on micro-gravity sensing.

Based on the modeling data and the data collected from the sensors in each integrated monitoring station 100, in some embodiments, the integrated monitoring system may include a calibration through a machine-learning algorithm employing surrogate models of the physics-based simulation of the carbon sequestration site.

In embodiments of the present disclosure, the machine learning techniques utilized may include, but are not limited to, one or more of the following: Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAID), Decision Stump, M5, Conditional Decision Trees, Naive Bayes, Gaussian Naive Bayes, Causality Networks (CN), Multinomial Naive Bayes, Averaged One-Dependence Estimators (AODE), Bayesian Belief Network (BBN), Bayesian Network (BN), k-Means, k-Medians, K-cluster, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Deep Boltzmann Machine (DBM), Deep Belief Networks (DBN), Convolutional Neural Network (CNN), Deep Metric Learning, Stacked Auto-Encoders, Dimensionality Reduction Algorithms, Principal Component Analysis (PCA), Principal Component Regression (PCR), Partial Least Squares Regression (PLSR), Collaborative Filtering (CF), Latent Affinity Matching (LAM), Cerebri Value Computation (CVC), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence (evolutionary algorithms, etc.), Computer Vision (CV), Natural Language Processing (NLP), Recommender Systems, Reinforcement Learning, Graphical Models, or combinations thereof.

From the utilization of the machine learning model and data collected from the integrated monitoring stations 100, the operations of the integrated monitoring system 300 and placement of integrated monitoring stations 100 in the integrated monitoring system 300 may be optimized.

In some embodiments, the optimized integrated monitoring system 300 may be presented to a user by data and a visual model of the data through the use of the software system 500, discussed below in reference to FIG. 5.

FIG. 4 depicts a block diagram of a platform system 400 for an integrated monitoring system, in accordance with certain embodiments of the present disclosure.

As shown in FIG. 4, the system platform 400 includes a sensor platform 410. The sensor platform may include a power transfer switch 411, which receives a power input from devices in the system platform 400 but external to the sensor platform 410. For example, in some embodiments, the power transfer switch 411 may receive power input from a solar panel 420. In certain embodiments, the power transfer switch 411 may receive power input from a shore power source 430.

Further shown in FIG. 4, the power transfer switch 411 may be operatively coupled to an uninterruptible power supply 412, which may provide emergency power to the sensor platform 410 when the input power source or main source of power fails.

The power received by the sensor platform 410 may then be provided to a power distribution 413 controlled by a switch that allows the distribution of power to be turned on or off based on a user's interactions with an interface panel. The user interface panel may also, in some embodiments, be communicatively coupled to a control unit 414, which may additionally control the power distribution 413 of the sensor platform 410.

In addition to the control over the power distribution 413, the control unit 414 may be configured to control the various sensors 416 in the sensor platform 410. The sensors 416 can include, as discussed in reference to the individual integrated monitoring station 100 of FIG. 1 above, a seismicity sensor, a surface deflection sensor, a water chemistry sensor, a micro-gravity sensor, an active seismic sensor, an electro-magnetic sensor, an SNSM sensor, a muon detection sensor, an in-situ XRF sensor, and combinations thereof.

For certain sensor types included in the sensors 416, the particular sensor may include one or more components with mechanical interfaces 460 or down-hole subsystems 420 external to the sensor platform 410. For example, a surface deflection sensor may include a corner reflector with a mechanical interface 460 external to the sensor platform 410. As another example, a water chemistry sensor may utilize multiple strands of a fiber bundle located external to the sensor platform 410 in a down-hole subsystem 420 that involves an assembly within the wellbore of the integrated monitoring system 300.

The data from the sensors 416 may be collected and then provided to the processing computer 415 in the sensor platform 410. The processing computer 415 may include, but is not limited to, databases for training data collection, modelling and analysis; processing capabilities; seismic processing; restful web services; and access, notifications, encryption, and support messaging processors. In addition to the data from the sensors 416, the processing computer 415 may receive data from the control unit 414. In some embodiments, the processing computer 415 may also receive data from devices external to the sensor platform 410 in the system platform 400. For example, as shown in FIG. 4, the system platform 400 may include a global positioning system 470 that can provide time and location data to the processing computer 415 in the sensor platform 410.

The processing computer may receive and transmit data to a cloud computing platform 450. The transmission of data may utilize an edge network to allow for a distributed architecture that processes data closer to users of the system platform 400.

The edge network may be considered to be a massively interconnected network where a number of IoT devices are in communications with each other. In some embodiments, communications in the edge network allows devices to discover each other and establish communications for interconnects.

The edge network may, in some embodiments, include multiple types of IoT devices. For example, the IoT devices in the edge network may include gateways, data aggregators, and sensors, or any combinations of such IoT devices.

The gateways may be edge devices that provide communications between the cloud computing platform 450 and the edge network. In certain embodiments, the gateways may also provide the backend process function for data obtained from sensors 416.

The data aggregators may collect data from any number of the sensors 416, and perform the back end processing function for the analysis. In various embodiments, the results, raw data, or a combination thereof may be passed along to the cloud computing platform 450 through the gateways.

In some embodiments, the sensors 416 may be full IoT devices. For example, the sensors 416 may be capable of both collecting data and processing the data. In other embodiments, the sensors 416 may collect the data and allow the data aggregators or gateways to process the data.

Communications from any IoT device may be passed along the most convenient path between any of the IoT devices to reach the gateways. In these networks, the number of interconnections provide substantial redundancy, allowing communications to be maintained, even with the loss of a number of IoT devices.

In certain embodiments, the platform 400 may use a mesh network to allow for IoT devices that are very low power or located at a distance from infrastructure to be used, as the range to connect to another IoT device may be significantly less than the range needed to connect to the gateways.

The edge network may be presented to devices in the cloud computing platform 450, such as a user interface 451 connected to the cloud 452. In some embodiments, the IoT devices may be configured using an imperative programming style to allow each IoT device to perform a specific function with specified communication partners.

In other embodiments, the IoT devices forming the edge network may be configured in a declarative programming style, allowing the IoT devices to reconfigure their operations and communications, such as to determine needed resources in response to questions regarding conditions of the system and the geologic carbon sequestration site. As an example, a question from a user operating from a user interface 451 about the operations of a particular integrated monitoring stations or particular sensors included in multiple integrated monitoring statements monitored by the IoT devices may result in the edge network selecting the IoT devices, such as particular sensors 416, needed to answer the question.

The data obtained from the sensors 416 may be aggregated, analyzed individually, analyzed in combination of one or more of the sensors 416, data aggregators, or gateways, before being sent on by the edge network for view on a user interface 451.

In some embodiments, the IoT devices in the edge network may select the sensors 416 to obtain data from. Further, in an embodiment where some of the IoT devices are not operational, other IoT devices in the edge network may provide analogous data.

Further, in some embodiments, the system platform 400 may include an air conditioning unit 480 to maintain the temperature of the integrated monitoring station 100, particular sensors 416, or combinations thereof. In certain embodiments, the sensor platform 410 includes a thermocouple 417 that measures the temperature of the sensor platform 410 or components therein, such as the sensors 416, processing computer 415, control unit 414, power distributor 413, uninterruptable power supply 412, and power transfer switch 411. Further, in such an embodiment, the thermocouple 417 is communicatively coupled to the air conditioning unit 480 such that the thermocouple 417 provides the air conditioning unit 480 with the temperature of the sensor platform 410 or components therein.

FIG. 5 depicts a block diagram of a software system 500 for use with an integrated monitoring system that includes multiple integrated monitoring stations, in accordance with certain embodiments of the present disclosure.

As discussed above in relation to FIG. 4, the cloud computing platform 450 may include cloud services that provide an edge computing network that can offer continuous reliability in data quality regardless of poor internet or other connectivity issues.

As shown in FIG. 5, the software system 500 can include a cloud services component 510, which is configured to receive and store data from each of the integrated monitoring stations in the integrated monitoring system. Specifically, the cloud services component 510 can be configured, in some embodiments, to receive information from the computing unit 520 of an integrated monitoring station 100. In some embodiments, there are a plurality of computing units 530a-530n, where n represents the total number of integrated monitoring stations in the integrated monitoring system, and each computing unit 530a-530n (in addition to computing unit 520) represent the computing units corresponding to each rated monitoring stations in the integrated monitoring system.

The computing unit 520 of an integrated monitoring station 100 may be coupled to the sensors present in the integrated monitoring station 100. In some embodiments, the computing unit 520 is additionally configured to receive information from and communicatively coupled to operate based on the information received external devices including but not limited to a global positioning system, battery voltage, environmental sensors monitoring conditions surrounding the integrated monitoring station 100, an HV/AC system, a power control, or combinations thereof.

In some embodiments, the computing unit 520 of an integrated monitoring station 100 includes cached data 521, a message queue 522, and an integrated monitoring station container 523. From the various sensors in the integrated monitoring station 100, such as for example a seismic sensor, a water chemistry sensor, and a micro-gravity sensor, the integrated monitoring station can collect data and the integrated monitoring station container 523 can perform an abstraction of such data. The abstraction data can then be sent to the integrated monitoring stations control software, contained in the integrated monitoring station container 523. In some embodiments, repeated abstraction for each sensor can be performed based on communicative coupling of the control software and the abstraction software in the integrated monitoring station container 523.

Information, such as data and control messages, from the cached data 521 and the integrated monitoring station container 523 can then be provided to a message queue 522 in the computing unit 520, which in turn provides such information to a cloud messaging queue 512 in the cloud services component 510. The cloud messaging queue 512 in the cloud services component 510 may then provide control data to the messaging queue 522 of the integrated monitoring station 100.

The messaging queue 522 and the cloud messaging queue 512 can include data regarding continuous measurements of seismic activity, water chemistry, micro-gravity, and any other sensors present in the integrated monitoring station 100.

In some embodiments, when the data is received by the cloud messaging queue 512, the data can be stored in the data storage 511 and later provided back to the cloud messaging queue 512 based on the communicative coupling of the software in the cloud services component 510. In some embodiments, when the data is received by the cloud messaging queue 512, the data is provided to an integrated monitoring station cloud container 513, which may perform a data analysis and utilize a cloud interface. In some embodiments, the utilization of a cloud interface in the integrated monitoring station cloud container 513 allows for a data visualizer to provide one or more pieces of the collected and analyzed data to a user of the integrated monitoring system 300.

The foregoing description, for purposes of explanation, used specific nomenclature to provide a thorough understanding of the described embodiments. However, it should be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It should be apparent to one of ordinary skill in the art that many modifications and variations are possible in view of the above teachings.

While embodiments of the disclosure have been shown and described, modifications thereof can be made by one skilled in the art without departing from the spirit and teachings of the disclosure. The embodiments described and the examples provided herein are exemplary only, and are not intended to be limiting. Many variations and modifications of the disclosure disclosed herein are possible and are within the scope of the disclosure. The scope of protection is not limited by the description set out above, but is only limited by the claims which follow, that scope including all equivalents of the subject matter of the claims.

Amounts and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of approximately 1 to approximately 4.5 should be interpreted to include not only the explicitly recited limits of 1 to approximately 4.5, but also to include individual numerals such as 2, 3, 4, and sub-ranges such as 1 to 3, 2 to 4, etc. The same principle applies to ranges reciting only one numerical value, such as “less than approximately 4.5,” which should be interpreted to include all of the above-recited values and ranges. Further, such an interpretation should apply regardless of the breadth of the range or the characteristic being described. The symbol “˜” is the same as “approximately”.

Unless defined otherwise, all technical and scientific terms used herein have the same meaning as commonly understood to one of ordinary skill in the art to which the presently disclosed subject matter belongs. Although any methods, devices, and materials similar or equivalent to those described herein can be used in the practice or testing of the presently disclosed subject matter, representative methods, devices, and materials are now described.

The above discussion is meant to be illustrative of the principles and various embodiments of the present disclosure. Numerous variations and modifications will become apparent to those skilled in the art once the above disclosure is fully appreciated. It is intended that the following claims be interpreted to embrace all such variations and modifications.

Those skilled in the art will appreciate that although the previous paragraphs relate to embodiments where steps may be described as occurring in a certain order, no ordering is required unless otherwise stated. In fact, steps described in the previous paragraphs may occur in any order. Furthermore, although one step may be described in one figure and another step may be described in another figure, embodiments of the present disclosure are not limited to such combinations, as any of the steps described above may be combined in particular embodiments.

Those skilled in the art will further appreciate that although the examples described above relate to embodiments where an artificial intelligence infrastructure supports the execution of machine learning models, the artificial intelligence infrastructure may support the execution of a broader class of Artificial Intelligence algorithms, including production algorithms. In fact, the steps described above may similarly apply to such a broader class of AI algorithms.

Those skilled in the art will further appreciate that although the embodiments described above relate to embodiments where the artificial intelligence infrastructure includes one or more storage systems and one or more GPU servers, in other embodiments, other technologies may be used. For example, in some embodiments the GPU servers may be replaced by a collection of GPUs that are embodied in a non-server form factor. Likewise, in some embodiments, the GPU servers may be replaced by some other form of computer hardware that can execute computer program instructions, where the computer hardware that can execute computer program instructions may be embodied in a server form factor or in a non-server form factor.

Example embodiments are described largely in the context of a fully functional computer system. Those having skill in the art will recognize, nonetheless, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method as embodied in a computer program product. Persons skilled in the art will recognize also that, although some of the example embodiments described in this specification are oriented to software installed and executing on computer hardware, nevertheless, alternative embodiments implemented as firmware or as hardware are well within the scope of the present disclosure.

Embodiments can include be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electro-magnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electro-magnetic waves, electro-magnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus, systems, systems-of-systems, and computer program products according to some embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those skilled in the art will appreciate that the steps described herein may be carried out in a variety ways and that no particular ordering is required. It will be further understood from the foregoing description that modifications and changes may be made in various embodiments of the present disclosure without departing from its true spirit. The descriptions in this specification are for purposes of illustration only and are not to be construed in a limiting sense.

Consistent with the above disclosure, the examples of systems and methods enumerated in the following clauses are specifically contemplated and are intended as a non-limiting set of examples.

Clause 1. A system for integrated monitoring of subsurface migration of CO₂ injected into deep rock formations, the system including a power supply configured to supply power to a sensor platform; the sensor platform including a plurality of sensors configured to collect monitoring data, where at least one sensor in the plurality of sensors includes a first sensor configured to collect first monitoring data on a first physical characteristic of a carbon sequestration site, where the first physical characteristic is selected from the group consisting of seismicity, near surface deformation, surface deformation, groundwater chemistry, gravity, atmospheric CO₂, soil CO₂, and CO₂ plume location, at least one sensor in the plurality of sensors includes a second sensor configured to collect second monitoring data on a second physical characteristic of the carbon sequestration site, where the second physical characteristic is selected from the group consisting of seismicity, near surface deformation, surface deformation, groundwater chemistry, gravity, atmospheric CO₂, soil CO₂, and CO₂ plume location, the first physical characteristic is a different physical characteristic than the second physical characteristic, the monitoring data includes the first monitoring data on the first physical characteristic and the second monitoring data on the second physical characteristic, and the sensor platform is configured to transmit the monitoring data to a processing computer; the processing computer configured to process the monitoring data, and transmit the monitoring data to a cloud computing platform; and the cloud computing platform communicatively coupled to the processing computer of the sensor platform.

Clause 2. The system of any foregoing clause, where the power supply includes a solar panel.

Clause 3. The system of any foregoing clause, where the sensor platform further includes an interface panel, where the interface panel is communicatively coupled to the processing computer and a power distribution unit, where the power distribution unit is operatively configured to supply power to the plurality of sensors.

Clause 4. The system of any foregoing clause, where the cloud computing platform further includes a cloud data storage, a cloud messaging queue, and a cloud data-analysis container.

Clause 5. The system of any foregoing clause, where the cloud messaging queue is configured to receive the monitoring data and one or more control messages from the processing computer.

Clause 6. The system of any foregoing clause, where the cloud computing platform further includes a user interface configured to present the monitoring data to a user of the system.

Clause 7. The system of any foregoing clause, where the cloud computing platform is configured to receive a remote instruction from a user using the user interface; the cloud computing platform is configured to transmit the remote instruction to the sensor platform; and the sensor platform is configured to operate in accordance with the remote instruction.

Clause 8. The system of any foregoing clause further including an air conditioning unit operatively connected to the sensor platform.

Clause 9. The system of any foregoing clause further including a global positioning system communicatively coupled to the processing computer of the sensor platform.

Clause 10. The system of any foregoing clause further including a third sensor configured to collect third monitoring data on a third physical characteristic of the carbon sequestration site, where the third physical characteristic is selected from the group consisting of seismicity, near surface deformation, surface deformation, groundwater chemistry, gravity, atmospheric CO₂, soil CO₂, and CO₂ plume location; a fourth sensor configured to collect fourth monitoring data on a fourth physical characteristic of the carbon sequestration site, where the fourth physical characteristic is selected from the group consisting of seismicity, near surface deformation, surface deformation, groundwater chemistry, gravity, atmospheric CO₂, soil CO₂, and CO₂ plume location; a fifth sensor configured to collect fifth monitoring data on a fifth physical characteristic of the carbon sequestration site, where the fifth physical characteristic is selected from the group consisting of seismicity, near surface deformation, surface deformation, groundwater chemistry, gravity, atmospheric CO₂, soil CO₂, and CO₂ plume location; and the first physical characteristic, the second physical characteristic, the third physical characteristic, the fourth physical characteristic, and the fifth physical characteristic are each different physical characteristics.

Clause 11. The system of any foregoing clause, where the sensor platform further includes a control unit, where the control unit is configured to control a remote activation of the plurality of sensors.

Clause 12. The system of any foregoing clause, where the control unit is configured to change the parameters of one or more sensors in the plurality of sensors.

Clause 13. The system of any foregoing clause, where the processing computer is configured to assess, based on the monitoring data, a first health value of the plurality of sensors and a second health value of the sensor platform; and transmit a notification when the where the first health value or the second health value is below a predetermined threshold.

Clause 14. The system of any foregoing clause further including an excitation source, where the excitation source is communicatively coupled to the sensor platform and operatively configured to produce an output that effects the first physical characteristic.

Clause 15. The system of any foregoing clause, where the excitation source is a seismic source.

Clause 16. An integrated monitoring station system including a plurality of sensors configured to collect monitoring data, where at least one sensor in the plurality of sensors includes a first sensor configured to monitor a first physical characteristic of a carbon sequestration site, where the first physical characteristic is selected from the group consisting of seismicity, near surface deformation, surface deformation, groundwater chemistry, gravity, atmospheric CO₂, soil CO₂, and CO₂ plume location, at least one sensor in the plurality of sensors includes a second sensor configured to monitor a second physical characteristic of the carbon sequestration site, where the second physical characteristic is selected from the group consisting of seismicity, near surface deformation, surface deformation, groundwater chemistry, gravity, atmospheric CO₂, soil CO₂, and CO₂ plume location, and the first physical characteristic is a different physical characteristic than the second physical characteristic; and an edge computing network communicatively coupled to the plurality of sensors, where the edge computing network is configured to store the monitoring data, process the monitoring data, and transmit the monitoring data to a cloud computing platform.

Clause 17. The system of any foregoing clause, where the plurality of sensors further includes a third sensor configured to monitor a third physical characteristic of the carbon sequestration site, where the third physical characteristic is selected from the group consisting of seismicity, near surface deformation, surface deformation, groundwater chemistry, gravity, atmospheric CO₂, soil CO₂, and CO₂ plume location; a fourth sensor configured to monitor a fourth physical characteristic of the carbon sequestration site, where the fourth physical characteristic is selected from the group consisting of seismicity, near surface deformation, surface deformation, groundwater chemistry, gravity, atmospheric CO₂, soil CO₂, and CO₂ plume location; a fifth sensor configured to monitor a fifth physical characteristic of the carbon sequestration site, where the fifth physical characteristic is selected from the group consisting of seismicity, near surface deformation, surface deformation, groundwater chemistry, gravity, atmospheric CO₂, soil CO₂, and CO₂ plume location; and the first physical characteristic, the second physical characteristic, the third physical characteristic, the fourth physical characteristic, and the fifth physical characteristic are each different physical characteristics.

Clause 18. The system of any foregoing clause, where the edge computing network further includes a cached data storage configured to store the monitoring data, where the monitoring data stored in the cached data storage is cached monitoring data.

Clause 19. The system of any foregoing clause, where the edge computing network further includes a messaging queue configured to transmit the cached monitoring data, the monitoring data, and control messages to the cloud computing platform.

Clause 20. The system of any foregoing clause, where the edge computing network is communicatively coupled to a global position system.

Clause 21. The system of any foregoing clause, where the edge computing network is operatively configured to receive power from an external battery voltage.

Clause 22. The system of any foregoing clause, where the edge computing network is operatively coupled to an HV/AC system.

Clause 23. The system of any foregoing clause, where the first sensor is an induced seismicity sensor and the first physical characteristic is seismicity.

Clause 24. The system of any foregoing clause, where the first sensor is a water chemistry sensor and the first physical characteristic is groundwater chemistry.

Clause 25. The system of any foregoing clause, where the first sensor is a micro-gravity sensor and the first physical characteristic is gravity.

Clause 26. The system of any foregoing clause, where the first sensor is an induced seismicity sensor and the first physical characteristic is seismicity, and the second sensor is a water chemistry sensor and the second physical characteristic is groundwater chemistry.

Clause 27. The system of any foregoing clause, where the edge computing network is communicatively coupled to a control unit, where the control unit is configured to control a remote activation of the plurality of sensors.

Clause 28. The system of any foregoing clause, where the control unit is configured to change the parameters of one or more sensors in the plurality of sensors.

Clause 29. The system of any foregoing clause further including an excitation source, where the excitation source is communicatively coupled to the edge computing network and operatively configured to produce an output that effects the first physical characteristic.

Clause 30. The system of any foregoing clause, where the excitation source is a seismic source.

Clause 31. A system for integrated monitoring of a subsurface gas storage site, the system including a power supply configured to supply power to a sensor platform; the sensor platform including a plurality of sensors configured to collect monitoring data, where at least one sensor in the plurality of sensors includes a first sensor configured to collect first monitoring data on a first physical characteristic of the subsurface gas storage site, where the first physical characteristic is selected from the group consisting of seismicity, near surface deformation, surface deformation, groundwater chemistry, gravity, atmospheric condition, soil condition, and subsurface storage location, at least one sensor in the plurality of sensors includes a second sensor configured to collect second monitoring data on a second physical characteristic of the subsurface gas storage site, where the second physical characteristic is selected from the group consisting of seismicity, near surface deformation, surface deformation, groundwater chemistry, gravity, atmospheric condition, soil condition, and subsurface storage location, the first physical characteristic is a different physical characteristic than the second physical characteristic, the monitoring data includes the first monitoring data on the first physical characteristic and the second monitoring data on the second physical characteristic, and the sensor platform is configured to transmit the monitoring data to a processing computer; the processing computer configured to process the monitoring data, and transmit the monitoring data to a cloud computing platform; and the cloud computing platform communicatively coupled to the processing computer of the sensor platform.

Clause 32. The system of any foregoing clause, where the subsurface gas storage site is configured for geologic carbon sequestration of CO₂.

Clause 33. The system of any foregoing clause, where the subsurface gas storage site is configured to house a gaseous fuel in a subsurface reservoir and the subsurface gas storage site is configured to allow the retrieval of the gaseous fuel from the subsurface reservoir.

Clause 34. The system of any foregoing clause, where the gaseous fuel is hydrogen fuel.

Clause 35. The system of any foregoing clause, where the gaseous fuel is methane.

Clause 36. The system of any foregoing clause, where the power supply includes a solar panel.

Clause 37. The system of any foregoing clause, where the sensor platform further includes an interface panel, where the interface panel is communicatively coupled to the processing computer and a power distribution unit, where the power distribution unit is operatively configured to supply power to the plurality of sensors.

Clause 38. The system of any foregoing clause, where the cloud computing platform further includes a cloud data storage, a cloud messaging queue, and a cloud data-analysis container.

Clause 39. The system of any foregoing clause, where the cloud messaging queue is configured to receive the monitoring data and one or more control messages from the processing computer.

Clause 40. The system of any foregoing clause, where the cloud computing platform further includes a user interface configured to present the monitoring data to a user of the system.

Clause 41. The system of any foregoing clause, where the cloud computing platform is configured to receive a remote instruction from a user using the user interface; the cloud computing platform is configured to transmit the remote instruction to the sensor platform; and the sensor platform is configured to operate in accordance with the remote instruction.

Clause 42. The system of any foregoing clause further including an air conditioning unit operatively connected to the sensor platform.

Clause 43. The system of any foregoing clause further including a global positioning system communicatively coupled to the processing computer of the sensor platform.

Clause 44. The system of any foregoing clause further including a third sensor configured to collect third monitoring data on a third physical characteristic of the subsurface gas storage site, where the third physical characteristic is selected from the group consisting of seismicity, near surface deformation, surface deformation, groundwater chemistry, gravity, atmospheric condition, soil condition, and subsurface storage location; a fourth sensor configured to collect fourth monitoring data on a fourth physical characteristic of the subsurface gas storage site, where the fourth physical characteristic is selected from the group consisting of seismicity, near surface deformation, surface deformation, groundwater chemistry, gravity, atmospheric condition, soil condition, and subsurface storage location; a fifth sensor configured to collect fifth monitoring data on a fifth physical characteristic of the subsurface gas storage site, where the fifth physical characteristic is selected from the group consisting of seismicity, near surface deformation, surface deformation, groundwater chemistry, gravity, atmospheric condition, soil condition, and subsurface storage location; and the first physical characteristic, the second physical characteristic, the third physical characteristic, the fourth physical characteristic, and the fifth physical characteristic are each different physical characteristics.

Clause 45. The system of any foregoing clause, where the sensor platform further includes a control unit, where the control unit is configured to control a remote activation of the plurality of sensors.

Clause 46. The system of any foregoing clause, where the control unit is configured to change the parameters of one or more sensors in the plurality of sensors.

Clause 47. The system of any foregoing clause further including an excitation source, where the excitation source is communicatively coupled to the sensor platform and operatively configured to produce an output that effects the first physical characteristic.

Clause 48. The system of any foregoing clause, where the excitation source is a seismic source.

Clause 49. An integrated monitoring station system including a plurality of sensors configured to collect monitoring data, where at least one sensor in the plurality of sensors includes a first sensor configured to monitor a first physical characteristic of a subsurface gas storage site, where the first physical characteristic is selected from the group consisting of seismicity, near surface deformation, surface deformation, groundwater chemistry, gravity, atmospheric condition, soil condition, and subsurface storage location, at least one sensor in the plurality of sensors includes a second sensor configured to monitor a second physical characteristic of the subsurface gas storage site, where the second physical characteristic is selected from the group consisting of seismicity, near surface deformation, surface deformation, groundwater chemistry, gravity, atmospheric condition, soil condition, and subsurface storage location, and the first physical characteristic is a different physical characteristic than the second physical characteristic; and an edge computing network communicatively coupled to the plurality of sensors, where the edge computing network is configured to store the monitoring data, process the monitoring data, and transmit the monitoring data to a cloud computing platform.

Clause 50. The system of any foregoing clause, where the subsurface gas storage site is configured for geologic carbon sequestration of CO₂.

Clause 51. The system of any foregoing clause, where the subsurface gas storage site is configured to house a gaseous fuel in a subsurface reservoir and the subsurface gas storage site is configured to allow the retrieval of the gaseous fuel from the subsurface reservoir.

Clause 52. The system of any foregoing clause, where the gaseous fuel is hydrogen fuel.

Clause 53. The system of any foregoing clause, where the gaseous fuel is methane.

Clause 54. The system of any foregoing clause, where the plurality of sensors further includes a third sensor configured to monitor a third physical characteristic of the subsurface gas storage site, where the third physical characteristic is selected from the group consisting of seismicity, near surface deformation, surface deformation, groundwater chemistry, gravity, atmospheric condition, soil condition, and subsurface storage location; a fourth sensor configured to monitor a fourth physical characteristic of the subsurface gas storage site, where the fourth physical characteristic is selected from the group consisting of seismicity, near surface deformation, surface deformation, groundwater chemistry, gravity, atmospheric condition, soil condition, and subsurface storage location; a fifth sensor configured to monitor a fifth physical characteristic of the subsurface gas storage site, where the fifth physical characteristic is selected from the group consisting of seismicity, near surface deformation, surface deformation, groundwater chemistry, gravity, atmospheric condition, soil condition, and subsurface storage location; and the first physical characteristic, the second physical characteristic, the third physical characteristic, the fourth physical characteristic, and the fifth physical characteristic are each different physical characteristics.

Clause 55. The system of any foregoing clause, where the edge computing network further includes a cached data storage configured to store the monitoring data, where the monitoring data stored in the cached data storage is cached monitoring data.

Clause 56. The system of any foregoing clause, where the edge computing network further includes a messaging queue configured to transmit the cached monitoring data, the monitoring data, and control messages to the cloud computing platform.

Clause 57. The system of any foregoing clause, where the edge computing network is communicatively coupled to a global position system.

Clause 58. The system of any foregoing clause, where the edge computing network is operatively configured to receive power from an external battery voltage.

Clause 59. The system of any foregoing clause, where the edge computing network is operatively coupled to an HV/AC system.

Clause 60. The system of any foregoing clause, where the first sensor is an induced seismicity sensor and the first physical characteristic is seismicity.

Clause 61. The system of any foregoing clause, where the first sensor is a tilt-meter sensor and the first physical characteristic is surface deformation.

Clause 62. The system of any foregoing clause, where the first sensor is a micro-gravity sensor and the first physical characteristic is gravity.

Clause 63. The system of any foregoing clause, where the first sensor is an induced seismicity sensor and the first physical characteristic is seismicity, and the second sensor is a tilt-meter and the second physical characteristic is surface deformation.

Clause 64. The system of any foregoing clause, where the edge computing network is communicatively coupled to a control unit, where the control unit is configured to control a remote activation of the plurality of sensors.

Clause 65. The system of any foregoing clause, where the control unit is configured to change the parameters of one or more sensors in the plurality of sensors.

Clause 66. The system of any foregoing clause further including an excitation source, where the excitation source is communicatively coupled to the edge computing network and operatively configured to produce an output that effects the first physical characteristic.

Clause 67. The system of any foregoing clause, where the excitation source is a seismic source.

What is claimed is:

1. A system for integrated monitoring of subsurface migration of CO₂ injected into deep rock formations, the system comprising:
(a) a power supply configured to supply power to a sensor platform;
(b) the sensor platform comprising:
(i) a plurality of sensors configured to collect monitoring data, wherein
(A) at least one sensor in the plurality of sensors comprises a first sensor configured to collect first monitoring data on a first physical characteristic of a carbon sequestration site, wherein the first physical characteristic is selected from the group consisting of seismicity, near surface deformation, surface deformation, groundwater chemistry, gravity, atmospheric CO₂, soil CO₂, and CO₂ plume location,
(B) at least one sensor in the plurality of sensors comprises a second sensor configured to collect second monitoring data on a second physical characteristic of the carbon sequestration site, wherein the second physical characteristic is selected from the group consisting of seismicity, near surface deformation, surface deformation, groundwater chemistry, gravity, atmospheric CO₂, soil CO₂, and CO₂ plume location,
(C) the first physical characteristic is a different physical characteristic than the second physical characteristic,
(D) the monitoring data comprises the first monitoring data on the first physical characteristic and the second monitoring data on the second physical characteristic, and
(E) the sensor platform is configured to transmit the monitoring data to a processing computer;
(ii) the processing computer configured to
(A) process the monitoring data, and
(B) transmit the monitoring data to a cloud computing platform; and
(c) the cloud computing platform communicatively coupled to the processing computer of the sensor platform.

2. The system of claim 1, wherein the power supply comprises a solar panel.

3. The system of claim 1, wherein the sensor platform further comprises an interface panel, wherein the interface panel is communicatively coupled to the processing computer and a power distribution unit, wherein the power distribution unit is operatively configured to supply power to the plurality of sensors.

4. The system of claim 1, wherein the cloud computing platform further comprises a cloud data storage, a cloud messaging queue, and a cloud data-analysis container.

5. The system of claim 4, wherein the cloud messaging queue is configured to receive the monitoring data and one or more control messages from the processing computer.

6. The system of claim 1, wherein the cloud computing platform further comprises a user interface configured to present the monitoring data to a user of the system.

7. The system of claim 6, wherein
(a) the cloud computing platform is configured to receive a remote instruction from a user using the user interface;
(b) the cloud computing platform is configured to transmit the remote instruction to the sensor platform; and
(c) the sensor platform is configured to operate in accordance with the remote instruction.

8. The system of claim 1 further comprising an air conditioning unit operatively connected to the sensor platform.

9. The system of claim 1 further comprising a global positioning system communicatively coupled to the processing computer of the sensor platform.

10. The system of claim 1 further comprising:
(a) a third sensor configured to collect third monitoring data on a third physical characteristic of the carbon sequestration site, wherein the third physical characteristic is selected from the group consisting of seismicity, near surface deformation, surface deformation, groundwater chemistry, gravity, atmospheric CO₂, soil CO₂, and CO₂ plume location;
(b) a fourth sensor configured to collect fourth monitoring data on a fourth physical characteristic of the carbon sequestration site, wherein the fourth physical characteristic is selected from the group consisting of seismicity, near surface deformation, surface deformation, groundwater chemistry, gravity, atmospheric CO₂, soil CO₂, and CO₂ plume location;
(c) a fifth sensor configured to collect fifth monitoring data on a fifth physical characteristic of the carbon sequestration site, wherein the fifth physical characteristic is selected from the group consisting of seismicity, near surface deformation, surface deformation, groundwater chemistry, gravity, atmospheric CO₂, soil CO₂, and CO₂ plume location; and
(d) the first physical characteristic, the second physical characteristic, the third physical characteristic, the fourth physical characteristic, and the fifth physical characteristic are each different physical characteristics.

11. The system of claim 1, wherein the sensor platform further comprises a control unit, wherein the control unit is configured to control a remote activation of the plurality of sensors.

12. The system of claim 11, wherein the control unit is configured to change the parameters of one or more sensors in the plurality of sensors.

13. The system of claim 1, wherein the processing computer is configured to
(a) assess, based on the monitoring data, a first health value of the plurality of sensors and a second health value of the sensor platform; and
(b) transmit a notification when x the first health value or the second health value is below a predetermined threshold.

14. The system of claim 1 further comprising an excitation source, wherein the excitation source is communicatively coupled to the sensor platform and operatively configured to produce an output that effects the first physical characteristic.

15. The system of claim 14, wherein the excitation source is a seismic source.

16. An integrated monitoring station comprising:
(a) a plurality of sensors configured to collect monitoring data, wherein
(i) at least one sensor in the plurality of sensors comprises a first sensor configured to monitor a first physical characteristic of a carbon sequestration site, wherein the first physical characteristic is selected from the group consisting of seismicity, near surface deformation, surface deformation, groundwater chemistry, gravity, atmospheric CO₂, soil CO₂, and CO₂ plume location,
(ii) at least one sensor in the plurality of sensors comprises a second sensor configured to monitor a second physical characteristic of the carbon sequestration site, wherein the second physical characteristic is selected from the group consisting of seismicity, near surface deformation, surface deformation, groundwater chemistry, gravity, atmospheric CO₂, soil CO₂, and CO₂ plume location, and
(iii) the first physical characteristic is a different physical characteristic than the second physical characteristic; and
(b) an edge computing network communicatively coupled to the plurality of sensors, wherein the edge computing network is configured to store the monitoring data, process the monitoring data, and transmit the monitoring data to a cloud computing platform.

17. The system of claim 16, wherein the plurality of sensors further comprises:
(a) a third sensor configured to monitor a third physical characteristic of the carbon sequestration site, wherein the third physical characteristic is selected from the group consisting of seismicity, near surface deformation, surface deformation, groundwater chemistry, gravity, atmospheric CO₂, soil CO₂, and CO₂ plume location;
(b) a fourth sensor configured to monitor a fourth physical characteristic of the carbon sequestration site, wherein the fourth physical characteristic is selected from the group consisting of seismicity, near surface deformation, surface deformation, groundwater chemistry, gravity, atmospheric CO₂, soil CO₂, and CO₂ plume location;
(c) a fifth sensor configured to monitor a fifth physical characteristic of the carbon sequestration site, wherein the fifth physical characteristic is selected from the group consisting of seismicity, near surface deformation, surface deformation, groundwater chemistry, gravity, atmospheric CO₂, soil CO₂, and CO₂ plume location; and
(d) the first physical characteristic, the second physical characteristic, the third physical characteristic, the fourth physical characteristic, and the fifth physical characteristic are each different physical characteristics.

18. The system of claim 16, wherein the edge computing network further comprises a cached data storage configured to store the monitoring data, wherein the monitoring data stored in the cached data storage is cached monitoring data.

19. The system of claim 18, wherein the edge computing network further comprises a messaging queue configured to transmit the cached monitoring data, the monitoring data, and control messages to the cloud computing platform.

20. The system of claim 16, wherein the edge computing network is communicatively coupled to a global position system.

21. The system of claim 16, wherein the edge computing network is operatively configured to receive power from an external battery voltage.

22. The system of claim 16, wherein the edge computing network is operatively coupled to an HV/AC system.

23. The system of claim 16, wherein the first sensor is an induced seismicity sensor and the first physical characteristic is seismicity.

24. The system of claim 16, wherein the first sensor is a water chemistry sensor and the first physical characteristic is groundwater chemistry.

25. The system of claim 16, wherein the first sensor is a micro-gravity sensor and the first physical characteristic is gravity.

26. The system of claim 16, wherein the first sensor is an induced seismicity sensor and the first physical characteristic is seismicity, and the second sensor is a water chemistry sensor and the second physical characteristic is groundwater chemistry.

27. The system of claim 16, wherein the edge computing network is communicatively coupled to a control unit, wherein the control unit is configured to control a remote activation of the plurality of sensors.

28. The system of claim 27, wherein the control unit is configured to change the parameters of one or more sensors in the plurality of sensors.

29. The system of claim 16 further comprising an excitation source, wherein the excitation source is communicatively coupled to the edge computing network and operatively configured to produce an output that effects the first physical characteristic.

30. The system of claim 29, wherein the excitation source is a seismic source.

31. A system for integrated monitoring of a subsurface gas storage site, the system comprising:
(a) a power supply configured to supply power to a sensor platform;
(b) the sensor platform comprising:
(i) a plurality of sensors configured to collect monitoring data, wherein
(A) at least one sensor in the plurality of sensors comprises a first sensor configured to collect first monitoring data on a first physical characteristic of the subsurface gas storage site, wherein the first physical characteristic is selected from the group consisting of seismicity, near surface deformation, surface deformation, groundwater chemistry, gravity, atmospheric condition, soil condition, and subsurface storage location,
(B) at least one sensor in the plurality of sensors comprises a second sensor configured to collect second monitoring data on a second physical characteristic of the subsurface gas storage site, wherein the second physical characteristic is selected from the group consisting of seismicity, near surface deformation, surface deformation, groundwater chemistry, gravity, atmospheric condition, soil condition, and subsurface storage location,
(C) the first physical characteristic is a different physical characteristic than the second physical characteristic,
(D) the monitoring data comprises the first monitoring data on the first physical characteristic and the second monitoring data on the second physical characteristic, and
(E) the sensor platform is configured to transmit the monitoring data to a processing computer;
(ii) the processing computer configured to
(A) process the monitoring data, and
(B) transmit the monitoring data to a cloud computing platform; and
(c) the cloud computing platform communicatively coupled to the processing computer of the sensor platform.

32. The system of claim 31, wherein the subsurface gas storage site is configured for geologic carbon sequestration of CO₂.

33. The system of claim 31, wherein the subsurface gas storage site is configured to house a gaseous fuel in a subsurface reservoir and the subsurface gas storage site is configured to allow the retrieval of the gaseous fuel from the subsurface reservoir.

34. The system of claim 33, wherein the gaseous fuel is hydrogen fuel.

35. The system of claim 33, wherein the gaseous fuel is methane.

36. The system of claim 31, wherein the power supply comprises a solar panel.

37. The system of claim 31, wherein the sensor platform further comprises an interface panel, wherein the interface panel is communicatively coupled to the processing computer and a power distribution unit, wherein the power distribution unit is operatively configured to supply power to the plurality of sensors.

38. The system of claim 31, wherein the cloud computing platform further comprises a cloud data storage, a cloud messaging queue, and a cloud data-analysis container.

39. The system of claim 38, wherein the cloud messaging queue is configured to receive the monitoring data and one or more control messages from the processing computer.

40. The system of claim 31, wherein the cloud computing platform further comprises a user interface configured to present the monitoring data to a user of the system.

41. The system of claim 40, wherein
(a) the cloud computing platform is configured to receive a remote instruction from a user using the user interface;
(b) the cloud computing platform is configured to transmit the remote instruction to the sensor platform; and
(c) the sensor platform is configured to operate in accordance with the remote instruction.

42. The system of claim 31 further comprising an air conditioning unit operatively connected to the sensor platform.

43. The system of claim 31 further comprising a global positioning system communicatively coupled to the processing computer of the sensor platform.

44. The system of claim 31 further comprising:
(a) a third sensor configured to collect third monitoring data on a third physical characteristic of the subsurface gas storage site, wherein the third physical characteristic is selected from the group consisting of seismicity, near surface deformation, surface deformation, groundwater chemistry, gravity, atmospheric condition, soil condition, and subsurface storage location;
(b) a fourth sensor configured to collect fourth monitoring data on a fourth physical characteristic of the subsurface gas storage site, wherein the fourth physical characteristic is selected from the group consisting of seismicity, near surface deformation, surface deformation, groundwater chemistry, gravity, atmospheric condition, soil condition, and subsurface storage location;
(c) a fifth sensor configured to collect fifth monitoring data on a fifth physical characteristic of the subsurface gas storage site, wherein the fourth physical characteristic is selected from the group consisting of seismicity, near surface deformation, surface deformation, groundwater chemistry, gravity, atmospheric condition, soil condition, and subsurface storage location; and
(d) the first physical characteristic, the second physical characteristic, the third physical characteristic, the fourth physical characteristic, and the fifth physical characteristic are each different physical characteristics.

45. The system of claim 31, wherein the sensor platform further comprises a control unit, wherein the control unit is configured to control a remote activation of the plurality of sensors.

46. The system of claim 45, wherein the control unit is configured to change the parameters of one or more sensors in the plurality of sensors.

47. The system of claim 31 further comprising an excitation source, wherein the excitation source is communicatively coupled to the sensor platform and operatively configured to produce an output that effects the first physical characteristic.

48. The system of claim 47, wherein the excitation source is a seismic source.

49. An integrated monitoring station comprising:
(a) a plurality of sensors configured to collect monitoring data, wherein
(i) at least one sensor in the plurality of sensors comprises a first sensor configured to monitor a first physical characteristic of a subsurface gas storage site, wherein the first physical characteristic is selected from the group consisting of seismicity, near surface deformation, surface deformation, groundwater chemistry, gravity, atmospheric condition, soil condition, and subsurface storage location,
(ii) at least one sensor in the plurality of sensors comprises a second sensor configured to monitor a second physical characteristic of the subsurface gas storage site, wherein the second physical characteristic is selected from the group consisting of seismicity, near surface deformation, surface deformation, groundwater chemistry, gravity, atmospheric condition, soil condition, and subsurface storage location, and
(iii) the first physical characteristic is a different physical characteristic than the second physical characteristic; and
(b) an edge computing network communicatively coupled to the plurality of sensors, wherein the edge computing network is configured to store the monitoring data, process the monitoring data, and transmit the monitoring data to a cloud computing platform.

50. The system of claim 49, wherein the subsurface gas storage site is configured for geologic carbon sequestration of CO₂.

51. The system of claim 49, wherein the subsurface gas storage site is configured to house a gaseous fuel in a subsurface reservoir and the subsurface gas storage site is configured to allow the retrieval of the gaseous fuel from the subsurface reservoir.

52. The system of claim 51, wherein the gaseous fuel is hydrogen fuel.

53. The system of claim 51, wherein the gaseous fuel is methane.

54. The system of claim 49, wherein the plurality of sensors further comprises:
(a) a third sensor configured to monitor a third physical characteristic of the subsurface gas storage site, wherein the third physical characteristic is selected from the group consisting of seismicity, near surface deformation, surface deformation, groundwater chemistry, gravity, atmospheric condition, soil condition, and subsurface storage location;
(b) a fourth sensor configured to monitor a fourth physical characteristic of the subsurface gas storage site, wherein the fourth physical characteristic is selected from the group consisting of seismicity, near surface deformation, surface deformation, groundwater chemistry, gravity, atmospheric condition, soil condition, and subsurface storage location;
(c) a fifth sensor configured to monitor a fifth physical characteristic of the subsurface gas storage site, wherein the fourth physical characteristic is selected from the group consisting of seismicity, near surface deformation, surface deformation, groundwater chemistry, gravity, atmospheric condition, soil condition, and subsurface storage location; and
(d) the first physical characteristic, the second physical characteristic, the third physical characteristic, the fourth physical characteristic, and the fifth physical characteristic are each different physical characteristics.

55. The system of claim 49, wherein the edge computing network further comprises a cached data storage configured to store the monitoring data, wherein the monitoring data stored in the cached data storage is cached monitoring data.

56. The system of claim 49, wherein the edge computing network further comprises a messaging queue configured to transmit the cached monitoring data, the monitoring data, and control messages to the cloud computing platform.

57. The system of claim 49, wherein the edge computing network is communicatively coupled to a global position system.

58. The system of claim 49, wherein the edge computing network is operatively configured to receive power from an external battery voltage.

59. The system of claim 49, wherein the edge computing network is operatively coupled to an HV/AC system.

60. The system of claim 49, wherein the first sensor is an induced seismicity sensor and the first physical characteristic is seismicity.

61. The system of claim 49, wherein the first sensor is a tilt-meter and the first physical characteristic is surface deformation.

62. The system of claim 49, wherein the first sensor is a micro-gravity sensor and the first physical characteristic is gravity.

63. The system of claim 49, wherein the first sensor is an induced seismicity sensor and the first physical characteristic is seismicity, and the second sensor is a tilt-meter and the second physical characteristic is surface deformation.

64. The system of claim 49, wherein the edge computing network is communicatively coupled to a control unit, wherein the control unit is configured to control a remote activation of the plurality of sensors.

65. The system of claim 64, wherein the control unit is configured to change the parameters of one or more sensors in the plurality of sensors.

66. The system of claim 49 further comprising an excitation source, wherein the excitation source is communicatively coupled to the edge computing network and operatively configured to produce an output that effects the first physical characteristic.

67. The system of claim 49, wherein the excitation source is a seismic source.
